(19) United States
(12) Patent Application Publication
(10) Pub. No.: US 2023/0324243 A1
(43) Pub. Date: Oct. 12, 2023

(54) PRESSURE SENSOR

(71) Applicant: ROHM CO., LTD., Kyoto (JP)

(72) Inventors: Martin Wilfried HELLER, Kyoto (JP); Nobuhisa YAMASHITA, Kyoto (JP)

(73) Assignee: ROHM CO., LTD., Kyoto (JP)

(21) Appl. No.: 18/194,088

(22) Filed: Mar. 31, 2023

(30) Foreign Application Priority Data
Apr. 12, 2022 (JP) 2022-065800

(51) Int. Cl. G01L 9/00; G01L 9/08

(52) U.S. Cl. CPC G01L 9/0026; G01L 9/08

(57) ABSTRACT

A pressure sensor includes: a substrate; a cavity provided in the substrate; a cap provided on the substrate and configured to seal the cavity; and a pressure conduit passing through the substrate and held in a hollow inside the cavity, wherein the pressure conduit includes a tubular insulating layer and a piezoelectric material layer, which is provided on an inner surface of the insulating layer and has a hollow portion therein, wherein the pressure conduit has one end closed in an inside of the cavity and the other end opened toward an outside of the substrate, and wherein the pressure sensor detects deformation of the pressure conduit due to a pressure difference between the outside of the substrate and the inside of the cavity as a change in voltage of the piezoelectric material layer.

### CROSS-REFERENCE TO RELATED APPLICATION

This application is based upon and claims the benefit of priority from Japanese Patent Application No. 2022-065800, filed on Apr. 12, 2022, the entire contents of which are incorporated herein by reference.

### TECHNICAL FIELD

The present disclosure relates to a pressure sensor having a MEMS structure, and more particularly to a pressure sensor using a piezoelectric material for a pressure conduit.

### BACKGROUND

In a pressure sensor using a MEMS structure, a tubular pressure conduit is placed in a cavity, which is formed on a silicon substrate and has a sealed interior. The pressure conduit is held in a hollow inside the cavity and an interior of the pressure conduit is in communication with an exterior of the pressure sensor. In addition, a transducer connected to the pressure conduit detects a deformation of the pressure conduit, which is caused by a pressure difference between an internal pressure of the cavity and an external pressure thereof, thereby detecting a change in ambient pressure (see, e.g., Patent Document 1).

### PRIOR ART DOCUMENT

[Patent Document]
Patent Document 1: Japanese Patent Laid-open Publication No. 2017-537302

However, the transducer has a capacitor structure constituted by electrodes arranged opposite to each other and detects a change in a spacing between the electrodes as a change in a capacitance of a capacitor, and generally includes a plurality of electrode pairs. As a result, there has been a problem that an area occupied by the pressure sensor becomes large. In addition, since the spacing between the electrodes of the transducer changes even when acceleration acts, there has also been a problem that an accurate pressure change cannot be detected under an environment where the acceleration acts.

### SUMMARY

Some embodiments of the present disclosure provide a pressure sensor that can measure a pressure with high precision and that can be miniaturized.

Some embodiments of the present disclosure provide a pressure sensor including: a substrate; a cavity provided in the substrate; a cap provided on the substrate and configured to seal the cavity; and a pressure conduit passing through the substrate and held in a hollow inside the cavity, wherein the pressure conduit includes a tubular insulating layer and a piezoelectric material layer, which is provided on an inner surface of the insulating layer and has a hollow portion therein, wherein the pressure conduit has one end closed in an inside of the cavity and the other end opened toward an outside of the substrate, and wherein the pressure sensor detects deformation of the pressure conduit due to a pressure difference between the outside of the substrate and the inside of the cavity as a change in voltage of the piezoelectric material layer.

### BRIEF DESCRIPTION OF DRAWINGS

The accompanying drawings, which are incorporated in and constitute a part of the specification, illustrate embodiments of the present disclosure.

FIG. 1 is a plan view schematically showing a pressure sensor according to a first embodiment of the present disclosure.

FIG. 2A is a cross-sectional view of a pressure conduit of FIG. 1 when viewed in a direction A-A.

FIG. 2B is a cross-sectional view of the pressure conduit of FIG. 1 when viewed in a direction B-B.

FIG. 3A is a cross-sectional view showing a manufacturing process of the pressure sensor according to the first embodiment of the present disclosure.

FIG. 3B is a cross-sectional view showing a manufacturing process of the pressure sensor according to the first embodiment of the present disclosure.

FIG. 3C is a cross-sectional view showing a manufacturing process of the pressure sensor according to the first embodiment of the present disclosure.

FIG. 3D is a cross-sectional view showing a manufacturing process of the pressure sensor according to the first embodiment of the present disclosure.

FIG. 3E is a cross-sectional view showing a manufacturing process of the pressure sensor according to the first embodiment of the present disclosure.

FIG. 3F is a cross-sectional view showing a manufacturing process of the pressure sensor according to the first embodiment of the present disclosure.

FIG. 4 is a plan view schematically showing a pressure sensor according to a second embodiment of the present disclosure.

FIG. 5A is a cross-sectional view of a pressure conduit of FIG. 4 when viewed in a direction C-C.

FIG. 5B is a cross-sectional view of the pressure conduit of FIG. 4 when viewed in a direction D-D.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### First Embodiment

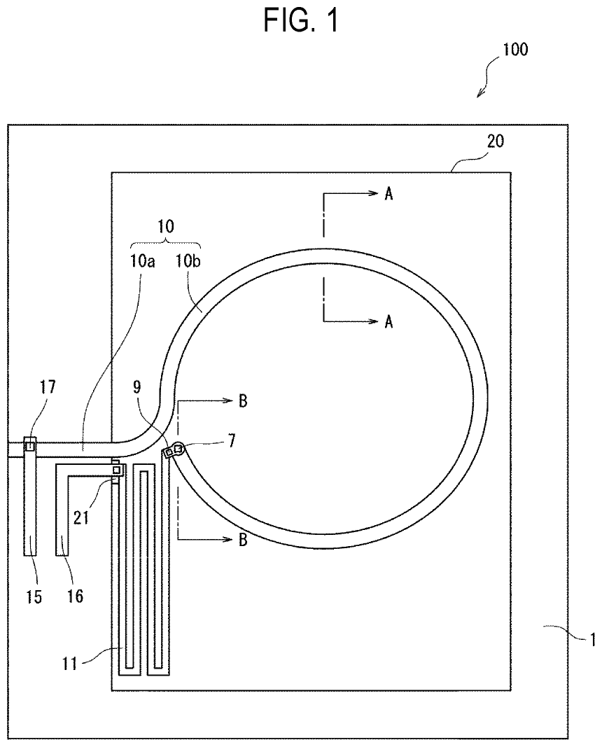

FIG. 1 is a plan view schematically showing a pressure sensor according to a first embodiment of the present disclosure, and the pressure sensor is denoted generally by reference numeral 100. The pressure sensor 100 includes a substrate 1 made of, for example, silicon. The substrate 1 is provided with a recessed cavity 20.

The pressure sensor 100 has a pressure conduit (Bourdon tube) 10 provided with a fixed part 10a and a movable part 10b. The fixed part 10a is provided in the substrate 1 around the cavity 20, and the movable part 10b is held in a hollow inside the cavity 20 in a floating state. In FIG. 1, the movable part 10b has a substantially circular shape, but it may have other curved shapes such as a semicircular shape as long as the movable part 10b is deformed by a pressure difference, as will be described later. The fixed part 10a may have a straight-line shape having a low resistance. However, the fixed part 10a may have a curved shape.

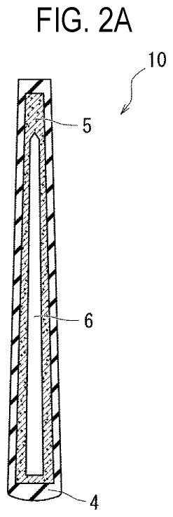

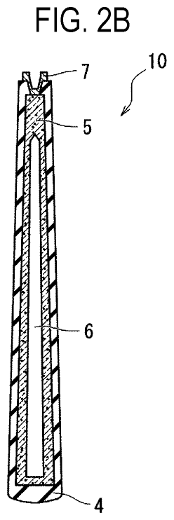

FIGS. 2A and 2B show cross-sectional views of the movable part 10b of the pressure conduit 10 when viewed in directions A-A and B-B, respectively. As shown in FIGS. 2A and 2B, an interior of the pressure conduit 10 is constituted by a hollow portion 6 as a tube. Specifically, the pressure conduit 10 includes an annular insulating layer 4 and a piezoelectric material layer 5 covering an inner wall thereof. The hollow portion 6 is formed inside the piezoelectric material layer 5. The insulating layer 4 is made of, for example, silicon oxide or silicon nitride. In addition, the piezoelectric material layer 5 is made of, for example, polycrystalline silicon doped with boron or aluminum, but it may employ other semiconductor materials, or may employ piezoelectric materials such as zinc oxide and barium lead titanate.

An end portion of the fixed part 10a of the pressure conduit 10 extends to a side surface of the substrate 1, and the hollow portion 6 is in communication with an external atmosphere. On the other hand, an end portion of the movable part 10b of the pressure conduit 10 is closed and is not in communication with an interior of the cavity 20. In addition, as shown in FIG. 2B, in a vicinity of the end portion of the movable part 10b, an upper portion of the insulating layer 4 is opened and a contact 7 is provided in the opening. The contact 7 is made of, for example, gold or aluminum and is electrically connected to the piezoelectric material layer 5. Similarly, a contact 17 electrically connected to the piezoelectric material layer 5 is provided in a vicinity of the end portion of the fixed part 10a of the pressure conduit 10.

Two lead wires 15 and 16 are provided on the substrate 1 outside the cavity 20. The lead wires 15 and 16 are made of, for example, gold or aluminum. The lead wire 15 is connected to the contact 17 of the fixed part 10a of the pressure conduit 10. On the other hand, the lead wire 16 passes over an insulation joint (IJ) 21 and is connected to a flexible lead 11. The flexible lead 11 itself deforms as the pressure conduit 10 deforms. The flexible lead 11 is made of, for example, gold or aluminum and is held in the hollow inside the cavity 20.

The substrate 1 is covered with a cap (not shown) made of, for example, a silicon substrate, so that the interior of the cavity 20 is sealed by the cap and the substrate 1. The interior of the cavity 20 may be in a vacuum state. As described above, the movable part 10b of the pressure conduit 10 and the flexible lead 11 are held in the hollow inside the sealed cavity 20.

Next, an operation principle of the pressure sensor 100 will be described. As described above, the pressure conduit 10 having a MEMS structure has a tubular structure with the end portion of the fixed part 10a opened and the end portion of the movable part 10b sealed. Therefore, an internal pressure of the pressure conduit 10 becomes equal to an ambient pressure of the pressure sensor 100, and a pressure difference is generated between the internal pressure of the pressure conduit 10 and the internal pressure of the cavity 20 sealed in a vacuum state. As this pressure difference increases, that is, as much as an external pressure becomes higher than the internal pressure (vacuum) of the cavity 20, the curved movable part 10b of the pressure conduit 10 is deformed to be extended.

Here, since the piezoelectric material layer 5 provided inside the pressure conduit 10 has a piezoelectric effect that generates a voltage according to deformation, when the movable part 10b of the pressure conduit 10 is deformed to be extended, a voltage between the two contacts 7 and 17 provided in the pressure conduit 10 changes. Therefore, it is possible to detect a change in the ambient pressure of the pressure sensor 100 by, for example, detecting a voltage between the lead wires 15 and 16.

As described above, in the pressure sensor 100 according to the embodiment of the present disclosure, the deformation of the pressure conduit 10 can be detected by using the piezoelectric material layer 5 provided in the pressure conduit 10. Therefore, the structure of the pressure sensor 100 becomes simpler than a conventional structure in which deformation of a pressure conduit is detected by a transducer provided outside the pressure conduit. In addition, since no transducer is required, it is also possible to miniaturize the pressure sensor 100.

In addition, since the pressure sensor 100 does not have a structure, such as a transducer, that is affected by a change in acceleration, it is possible to detect a pressure with high precision. Thus, it is possible to achieve integration with an acceleration sensor (inertial sensor).

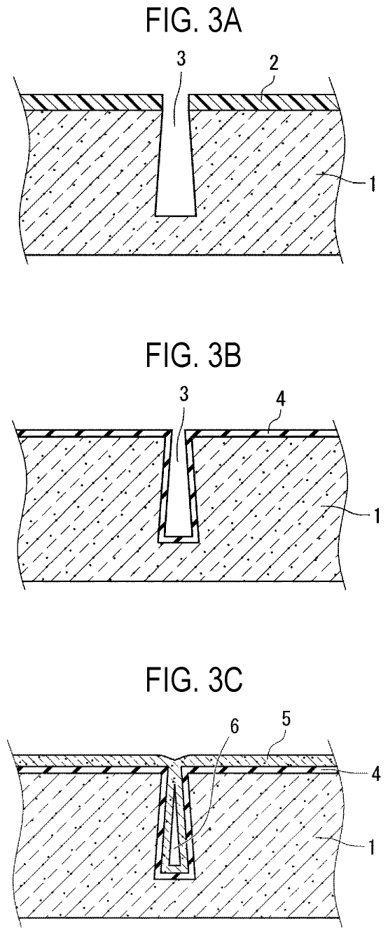

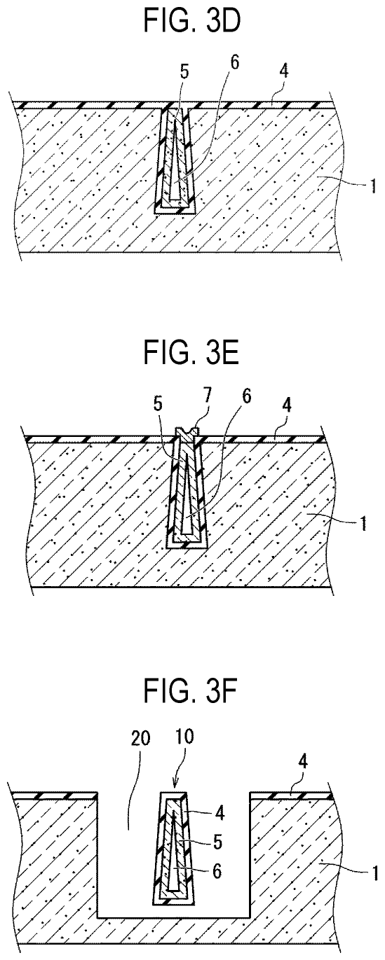

Next, a method of manufacturing the pressure sensor 100 will be described briefly. FIGS. 3A to 3F show a manufacturing method of the pressure sensor 100 according to the first embodiment. In FIGS. 3A to 3F, the same reference numerals as in FIG. 1 denote the same or equivalent portions. The manufacturing method includes processes 1 to 7 described below.

Process 1: As shown in FIG. 3A, the substrate 1 made of, for example, silicon, is prepared, and a photoresist mask 2 is formed on a surface of the substrate 1 by using photolithography. Subsequently, by using the photoresist mask 2 as an etching mask, the substrate 1 is etched to form a groove 3. The groove 3 is formed at a location of the pressure conduit 10 shown in FIG. 1. Etching the substrate 1 is performed by plasma etching using, for example, SF₆ gas. The groove 3 is etched so that a width of an opening increases from the surface toward a depth direction.

Process 2: As shown in FIG. 3B, after removing the photoresist mask 2 by using an organic solvent or the like, the substrate 1 is thermally oxidized. As a result, the insulating layer 4 made of, for example, silicon dioxide is formed continuously to cover the surface of the substrate 1 and a wall surface of the groove 3.

Process 3: As shown in FIG. 3C, the piezoelectric material layer 5 made of, for example, polycrystalline silicon doped with boron is formed isotropically. The piezoelectric material layer 5 is fabricated by thermal CVD or plasma CVD using, for example, SiH₄ gas. B₂H₆ gas, for example, is used for boron doping. Since the opening width of the groove 3 increases from the surface toward the depth direction, the piezoelectric material layer 5 is formed to close the opening of the groove 3 while leaving the hollow portion 6 thereinside.

Process 4: As shown in FIG. 3D, the piezoelectric material layer 5 on the insulating layer 4 is removed by selective etching using the insulating layer 4 as a stopper. Subsequently, the piezoelectric material layer 5 in the opening at an upper portion of the groove 3 is oxidized by, for example, thermal oxidation. As a result, the piezoelectric material layer 5 is formed in the groove 3 to surround the hollow portion 6, and the insulating layer 4 is formed to surround the piezoelectric material layer 5.

Process 5: As shown in FIG. 3E, the insulating layer 4 on the piezoelectric material layer 5 is removed to form the contact 7 at a predetermined position. Subsequently, the flexible lead 11 is formed by a vapor deposition method. In addition, the lead wire 15 connected to the contact 17 and the lead wire 16 connected to the flexible lead 11 are formed by, for example, vapor deposition. The contacts 7 and 17, the flexible lead 11, and the lead wires 15 and 16 are made of, for example, gold or aluminum.

Process 6: As shown in FIG. 3F, in a cavity forming region, the insulating layer 4 on the surface is removed except for the insulating layer 4 on the groove 3. Subsequently, by using the remaining insulating layer 4 as an etching mask, the substrate 1 is selectively etched to form the cavity 20. In the selective etching process of the substrate 1, the pressure conduit 10 surrounded by the insulating layer 4 is not etched, and the pressure conduit 10 and the flexible lead 11 are held in the hollow inside the cavity 20 in a floating state.

Process 7: Finally, a cap (not shown) is bonded to the substrate 1 to seal the interior of the cavity 20. The interior of the cavity 20 becomes a vacuum state by performing the cap bonding process in a vacuum.

Through the processes described above, the pressure sensor 100, which is provided with the pressure conduit 10 having the fixed part 10a buried in the substrate 1 and the movable part 10b held in the hollow inside the cavity 20, is completed.

### Second Embodiment

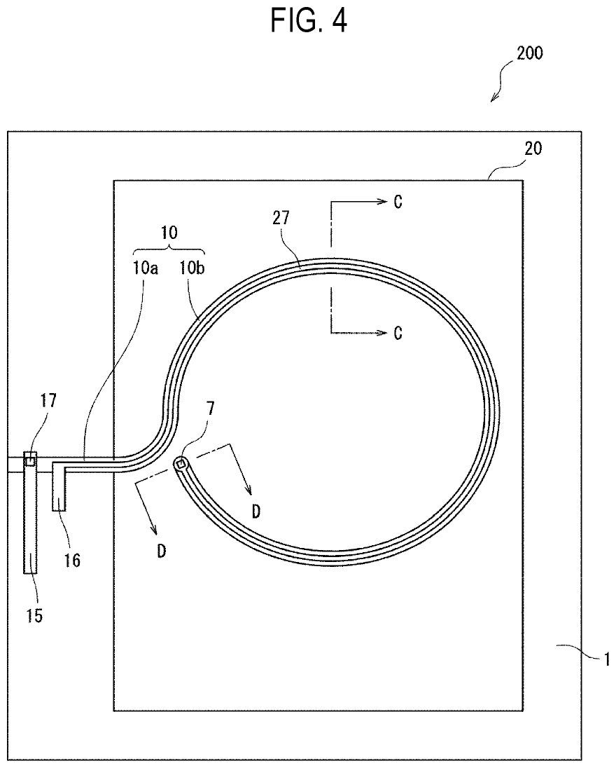

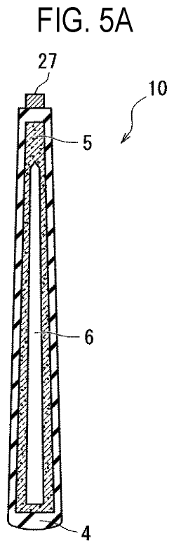

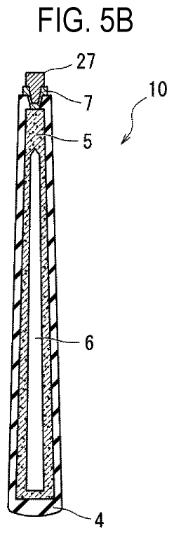

FIG. 4 is a plan view schematically showing a pressure sensor according to a second embodiment of the present disclosure, and the pressure sensor is denoted generally by reference numeral 200. FIGS. 5A and 5B are cross-sectional views of a pressure conduit 10 of FIG. 4 when viewed in directions C-C and D-D, respectively. In FIGS. 4 to 5B, the same reference numerals as in FIG. 1 denote the same or equivalent portions.

In the above-described pressure sensor 100, the flexible lead 11 is used to connect between the contact 7 at the end portion of the movable part 10b of the pressure conduit 10 and the lead wire 16. However, in the pressure sensor 200 according to the second embodiment of the present disclosure, a wiring layer 27 provided on the pressure conduit 10 is used for the connection. Other structures are the same as the pressure sensor 100.

As shown in FIG. 5A, the wiring layer 27 is provided over the insulating layer 4 on an upper portion of the pressure conduit 10 along the pressure conduit 10. The wiring layer 27 is made of, for example, gold or aluminum and is formed by a vapor deposition method or the like. In addition, as shown in FIG. 5B, at the end portion of the movable part 10b of the pressure conduit 10, the wiring layer 27 is connected to the piezoelectric material layer 5 via the contact 7.

In the pressure sensor 200, it is possible to detect a change in an ambient pressure of the pressure sensor 200 by, for example, detecting a voltage between the lead wires 15 and 16.

In particular, since the wiring layer 27 provided on the pressure conduit 10 is used instead of the flexible lead 11, it is possible to further miniaturize the pressure sensor 200 and simplify a structure of the pressure sensor 200.

### <Supplementary Notes>

The present disclosure provides a pressure sensor including:
a substrate;
a cavity provided in the substrate;
a cap provided on the substrate and configured to seal the cavity; and
a pressure conduit passing through the substrate and held in a hollow inside the cavity,
wherein the pressure conduit includes a tubular insulating layer and a piezoelectric material layer, which is provided on an inner surface of the insulating layer and has a hollow portion therein,
wherein the pressure conduit has one end closed in an inside of the cavity and the other end opened toward an outside of the substrate, and
wherein the pressure sensor detects deformation of the pressure conduit due to a pressure difference between the outside of the substrate and the inside of the cavity as a change in voltage of the piezoelectric material layer.

With such a configuration, it is possible to provide a compact pressure sensor capable of measuring a pressure with high precision.

In the pressure sensor of the present disclosure, the piezoelectric material layer has one end connected to a first lead wire and the other end connected to a second lead wire via a flexible lead held in the hollow inside the cavity, and the pressure sensor further detects a change in voltage between the first lead wire and the second lead wire.

With such a configuration, it is possible to provide a compact pressure sensor capable of measuring a pressure with high precision.

In the pressure sensor of the present disclosure, the piezoelectric material layer has one end connected to a first lead wire and the other end connected to a second lead wire via a wiring layer provided on the pressure conduit, and the pressure sensor detects a change in voltage between the first lead wire and the second lead wire.

With such a configuration, it is possible to provide a more miniaturized pressure sensor capable of measuring a pressure with high precision.

In the pressure sensor of the present disclosure, the pressure conduit has a curved portion held in the hollow inside the cavity.

With such a configuration, it is possible to measure a pressure with high precision.

In the pressure sensor of the present disclosure, the insulating layer is made of silicon oxide, and the piezoelectric material layer is made of polycrystalline silicon.

Such a configuration facilitates a manufacturing process of the pressure sensor.

### INDUSTRIAL APPLICABILITY

The pressure sensor having a MEMS structured provided with the pressure conduit according to the present disclosure can be applied to a pressure sensor for measuring an ambient air pressure, a pressure sensor integrated with an acceleration sensor, and the like.

According to the present disclosure in some embodiments, it is possible to provide a compact pressure sensor capable of measuring a pressure with high precision.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A pressure sensor comprising:
a substrate;
a cavity provided in the substrate;
a cap provided on the substrate and configured to seal the cavity; and
a pressure conduit passing through the substrate and held in a hollow inside the cavity,
wherein the pressure conduit includes a tubular insulating layer and a piezoelectric material layer, which is provided on an inner surface of the insulating layer and has a hollow portion therein,
wherein the pressure conduit has one end closed in an inside of the cavity and the other end opened toward an outside of the substrate, and
wherein the pressure sensor detects deformation of the pressure conduit due to a pressure difference between the outside of the substrate and the inside of the cavity as a change in voltage of the piezoelectric material layer.

2. The pressure sensor of claim 1, wherein the piezoelectric material layer has one end connected to a first lead wire and the other end connected to a second lead wire via a flexible lead held in the hollow inside the cavity, and
wherein the pressure sensor further detects a change in voltage between the first lead wire and the second lead wire.

3. The pressure sensor of claim 1, wherein the piezoelectric material layer has one end connected to a first lead wire and the other end connected to a second lead wire via a wiring layer provided on the pressure conduit, and
wherein the pressure sensor further detects a change in voltage between the first lead wire and the second lead wire.

4. The pressure sensor of claim 1, wherein the pressure conduit has a curved portion held in the hollow inside the cavity.

5. The pressure sensor of claim 1, wherein the insulating layer is made of silicon oxide, and the piezoelectric material layer is made of polycrystalline silicon.
